(19) United States
(12) Patent Application Publication
(10) Pub. No.: US 2006/0255587 A1
(43) Pub. Date: Nov. 16, 2006

(54) Sheet element, of a banknote type, document with intrinsic value or the like, with security means

(76) Inventor: Maurizio Lazzerini, Cerron Al Lambro (IT)

Correspondence Address: Modiano & Associati, Via Meravigli 16, Milano, 20123, IT

(21) Appl. No.: 10/554,684

(22) PCT Filed: May 6, 2004
(86) PCT No.: PCT/IB04/01423

§ 371 Date: Oct. 27, 2005

(30) Foreign Application Priority Data
May 8, 2003 (IT) MI2003A000928

(51) Int. Cl. B42D 15/00

(52) U.S. Cl. 283/72

(57) ABSTRACT

A sheet element, such as a banknote, a document with intrinsic value and the like, with security means, which comprises a sheet-shaped element that incorporates a security element, preferably in the form of a strip. Windows are formed in the sheet-like element at the security element. The particularity of the invention is constituted by the fact that the number of windows is correlated to the face value of the banknote.

### TECHNICAL FIELD

The present invention relates to a sheet element, such as a banknote, a document with intrinsic value and the like, with security means.

### BACKGROUND OF THE INVENTION

As is known, the various anticounterfeiting systems meant to allow the public to interpret the validity of a document, such as banknotes and the like, include the system that allows to make a security thread, embedded in the paper, appear in the regions where the paper is thinner.

This method provides for thicker regions of the paper, that are arranged alternately with respect to other thinner regions which follow a line that is parallel to the direction of production of the paper, normally to the shorter side of a banknote.

These thinner areas allow the inserted safety thread to appear where the paper is thinner, since the fibers of the paper are unable to cover the surface of the thread.

Over time, additional solutions have been proposed which made available to the public elements allowing easy and assured interpretation, such as for example the provision of texts in negative form on the thread inserted in the paper with the above described “in and out” method, which is known in the jargon as “windowing”.

This solution constituted a significant feature, since the presence on the thread of a text in negative form, introduced as described above, has a graphical continuity, and therefore a reading continuity, that is independent of the thickness of the paper if the document is viewed in transmitted light.

In order to better clarify this aspect, suppose that a text or continuous design is printed in negative form on the thread and inserted as described earlier; if the banknote is viewed in transmitted light, the lettering on the thread will be visible regardless of the position of the “windows” provided by the reduced thickness of the paper.

In the solutions that are currently used, these windows are distributed uniformly along the height of the banknote and their number usually depends on the height of the banknote.

### SUMMARY OF THE INVENTION

The aim of the invention is to provide a sheet element, such as a banknote, a document with intrinsic value and the like, with security means, that allows to further increase the obtainable security characteristics by providing a further element that can be linked to the value of the banknote.

Within this aim, an object of the invention is to provide a sheet element it which it is possible to utilize the windows provided at the security element in thread form, to provide additional safety criteria.

Another object of the present invention is to provide a sheet element that allows to facilitate tactile identification of the document.

Another object of the present invention is to provide a sheet element that thanks to its particular production characteristics is capable of giving the greatest assurances of reliability and safety in use.

This aim and these and other objects that will become better apparent hereinafter are achieved by a sheet element, such as a banknote, a document with intrinsic value and the like, with security means, according to the invention, comprising a sheet-like element that incorporates a security element in the form of a strip, windows being formed in said sheet-like element at said security element, characterized in that the number of said windows is correlated to the face value of the sheet element.

### BRIEF DESCRIPTION OF DRAWINGS

Further characteristics and advantages will become better apparent from the description of a preferred but not exclusive embodiment of a sheet element, such as a banknote, a document with intrinsic value and the like, with security means, illustrated by way of non-limiting example in the accompanying drawings, wherein:

FIGS. 1, 2 and 3 are views of three banknotes having different face values, with openings that are correlated to the face value;

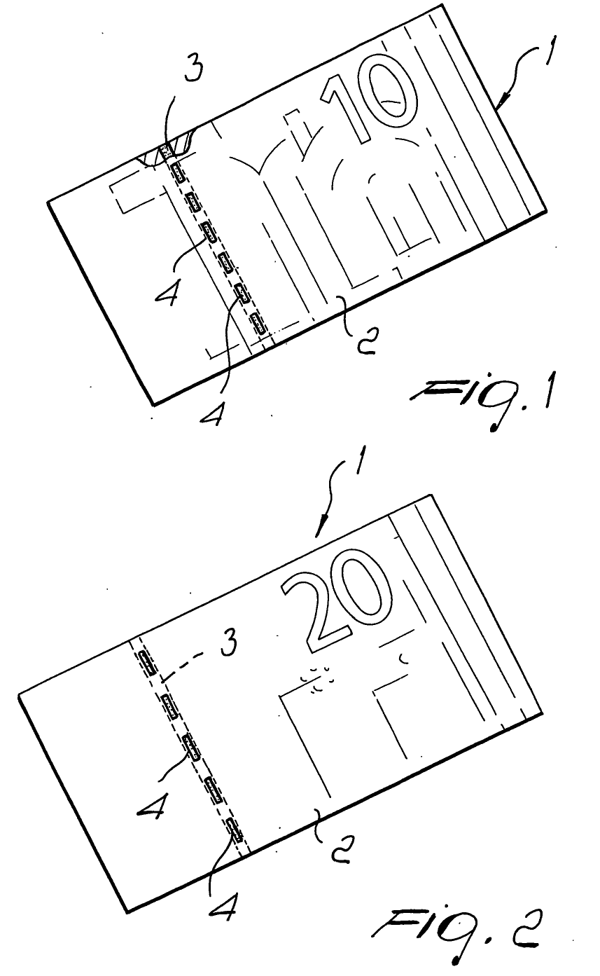

FIG. 4 is a view of a banknote in which the windows provide a code.

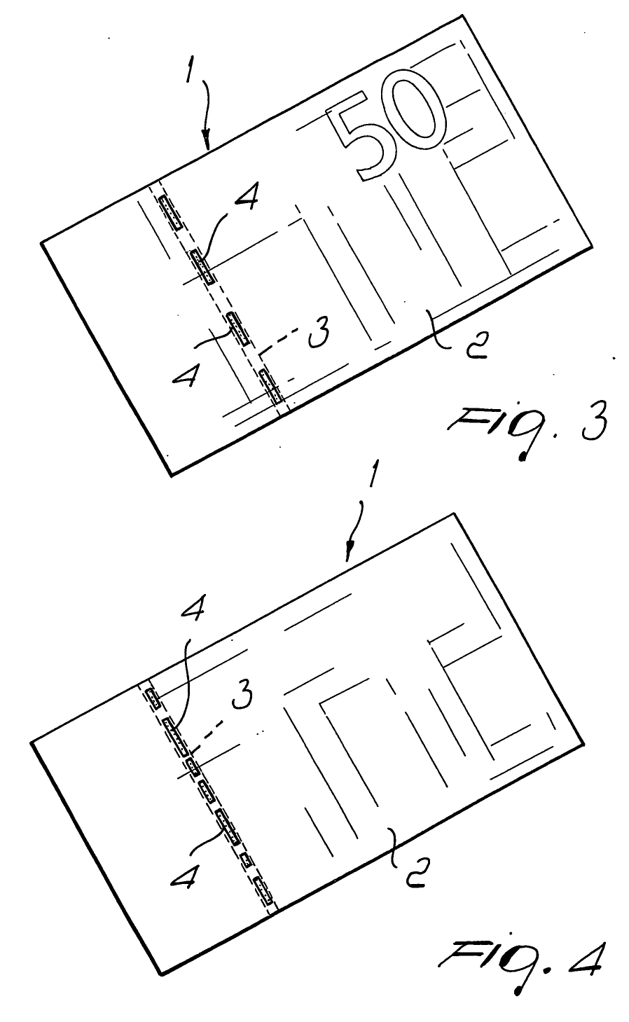

### WAYS OF CARRYING OUT THE INVENTION

With reference to the figures, the sheet element, such as a banknote, a document with intrinsic value and the like, with security means, according to the invention, generally designated by the reference numeral 1, comprises a sheet-like element 2, which is made for example of security paper and inside which, by a known method, for example of the type disclosed in U.S. Pat. No. 4,186,943, a security element is incorporated in the form of a strip or band, designated by the reference numeral 3, which can be of any type and can bear graphic markings, designs and the like provided according to the most disparate methods.

Windows 4 are provided in the sheet-like element 2, at least at the region affected by the security element 3, and the security element is visible externally through said windows.

The characterizing feature of the invention consists in that the windows 4 are provided in a manner that is correlated to the face value of the banknote.

In particular, it is possible to provide a number of windows 4 that varies according to the face value of the banknote and preferably decreases as the value of the banknote increases.

For example, a banknote with a nominal value of 10, as shown in the drawings, can have six windows, a banknote with a face value of 20 has five windows, a banknote with a face value of 50 has four windows, and so forth.

The dimensions of the windows can vary depending on their number, i.e., can increase in length as the number of windows decreases.

The placement of more windows on the banknote that has the lowest face value arises from the fact that it prevents attempts to add windows in order to raise the value of the banknote.

It should be noted that it is also possible to correlate the size of the windows to the face value, i.e., to provide windows that increase in size as the face value decreases; it is also possible to vary the contour of the windows depending on the face value or to provide a combination of contours.

In order to ensure correct insertion of the security thread, the thread or strip that is embedded in the sheet-like element has appropriately dedicated thermoadhesive characteristics.

It should be further added that by utilizing the same type of production it is possible to provide, on the sheet-like element that constitutes a document of any kind, windows whose length and mutual distance can provide a code; i.e., it is possible, by varying the dimension and mutual distance of the various windows, to provide an element that can be detected both optically and by appropriate devices.

From what has been described above, it is thus evident that the invention achieves the proposed aim and objects, and in particular the fact is stressed that a sheet element, such as a banknote, a document with intrinsic value and the like, is provided in which it is possible to provide an additional security criterion that allows to correlate the number of windows provided at the security element with the face value of the banknote.

The invention thus conceived is susceptible of numerous modifications and variations, all of which are within the scope of the inventive concept.

All the details may further be replaced with other technically equivalent elements.

In practice, the materials used, as well as the contingent shapes and dimensions, may be any according to requirements.

The disclosures in Italian Patent Application no. MI2003A000928, from which this application claims priority, are incorporated herein by reference.

What is claimed is:

1-9. (canceled)

10. A sheet element of a banknote type with security means, comprising: a sheet-shaped element that incorporates a security element in the form of a strip; and windows being formed in said sheet-shaped element at said security element, wherein number of said windows is correlated to the face value of the banknote.

11. A sheet element of a banknote type with security means, comprising: a sheet-shaped element that incorporates a security element in the form of a strip; and windows being formed in said sheet-shaped element at said security element, wherein size of said windows is correlated to the face value of the banknote.

12. A sheet element of a banknote type, with security means, comprising: a sheet-shaped element that incorporates a security element in the form of a strip; and windows being formed in said sheet-shaped element at said security element, wherein contour of said windows is correlated to the face value of the banknote.

13. A document with security means, comprising: a sheet-shaped element that incorporates a security element in the form of a strip; and windows being formed in said sheet-shaped element at said security element, and wherein dimensions and mutual distance of said windows is variable so as to form a code that can be detected visually and/or by way of adapted detection devices.

14. The sheet element of claim 10, wherein the number of said windows decreases as said face value of the banknote increases.

15. The sheet element of claim 11, wherein the size of said windows increases as the number of said windows decreases.

16. The sheet element of claim 10, wherein said windows are uniformly distributed.

17. The sheet element of claim 12, wherein said windows have a combination of contours depending on said face value.

18. The sheet element of claim 10, wherein said windows can be detected by touching.
